(19) United States
(12) Patent Application Publication
(10) Pub. No.: US 2002/0040873 A1
(43) Pub. Date: Apr. 11, 2002

(54) Method and apparatus for purifying nucleic acids

(76) Inventors: Johan Wahlberg, Stockholm (SE); R. Scott Duthie, Califon, NJ (US); Peter Hewitt, Doylestown, PA (US)

Correspondence Address: Amersham Pharmacia Biotech, Inc., 800 Centennial Avenue, Piscataway, NJ, 08855, US

(21) Appl. No.: 09/876,694

(22) Filed: Jun. 7, 2001

Related U.S. Application Data
(60) Provisional application No. 60/210,062, filed on Jun. 7, 2000.

(51) Int. Cl. B01D 15/08; B01D 61/00

(52) U.S. Cl. 210/635; 435/2; 530/417

(57) ABSTRACT

The instant invention relates to a method and an apparatus useful for purifying DNA sequencing reaction products. Briefly, a gel filtration medium is combined with a molecular cutoff filter in a single apparatus to isolate DNA sequencing fragments from the sequencing template, enzyme, salt and nucleotides. A preferred embodiment of the instant apparatus depicted in FIG. 1 shows a cylindrical housing having openings at the top and bottom of the housing. The housing may take forms other than cylindrical, e.g., rectangular, octagonal, etc.

The apparatus may be used in conjunction with pressure and/or centrifugation to achieve the separation, and the addition of a detergent composition (nonionic, ionic, or zwitterionic), including a bile salt, may also be used.

This application is a continuation-in-part of U.S. Provisional Patent Application Ser. No. 60/210,062, filed Jun. 7, 2000, now abandoned.

### BACKGROUND OF THE INVENTION

The instant disclosure pertains to a method and an apparatus useful for removing impurities such as salts, nucleotides, terminators, and template from DNA sequencing reaction products.

In the late 1970's, Sanger et al. developed an enzymatic chain termination method for DNA sequence analysis that produced a nested set of DNA fragments with a common starting point and random terminations at every nucleotide throughout the sequence. Lloyd Smith, Lee Hood, and others modified the Sanger method to use four fluorescent labels in sequencing reactions and performed single lane, slab gel separations resulting in the creation of the first automated DNA sequencers. More recently, fluorescent energy-transfer dyes have been used to make dye sets that enhance signals by two to ten fold and simplify the optical configuration.

Automated fluorescent capillary array electrophoresis (CAE) DNA sequencing is quickly replacing slab gel technology. Capillary electrophoresis speeds up the separation of sequencing products. For example, the 96-channel MegaBACE™ CAE instrument, which is commercially available from Molecular Dynamics located in Sunnyvale, Calif., uses a laser induced fluorescence confocal scanner to detect up to an average of about 625 bases per capillary (Phred 20 window; 99% accuracy) in 90 minute runs with cycle times of two hours. Confocal spatial filtering results in a higher signal-to-noise ratio because superfluous reflections and fluorescence from surrounding materials are minimized before signal detection at the photomultiplier tube. Accordingly, sensitivity at the level of subattomoles per sequencing band is attainable.

Although capillary array electrophoresis systems solve many of the needs of the genomic community for DNA analysis, capillary electrophoresis is more sensitive than slab gel technology to the remnants of completed sequencing reactions. For example, components such as salt and unincorporated nucleotides may affect the amount of DNA sequencing fragments loaded during electrokinetic injection (M. C. Ruiz-Martinez et al., A Sample Purification Method for Rugged and High-Performance DNA Sequencing by Capillary Electrophoresis Using Replaceable Polymer Solutions. A. Development of the Cleanup Protocol, 70 Anal. Chem. 1516-1527 (1998); and O. Salas-Solano et al., A Sample Purification Method for Rugged and High-Performance DNA Sequencing by Capillary Electrophoresis Using Replaceable Polymer Solutions. B. Quantitative Determination of the Role of Sample Matrix Components on Sequencing Analysis, 70 Anal. Chem. 1528-1535 (1998). Similarly, it has been shown that excess template can affect the amount of DNA sequencing fragments injected, as well as decrease the separation efficiency (Amersham Pharmacia Biotech Inc. MegaMANUAL, Chapter 3). Conventional methods for purifying sequencing reaction products, such as ethanol precipitation, do not always reduce the level of components to an acceptable level. These remnants can cause short, ambiguous sequencing reads. In severe instances, the remaining components can render the sequencing read totally unintelligible (FIG. 3 arrows and bottom panel).

Present efforts to identify and understand disease causing genes depend on the ability to sequence massive numbers of samples accurately, quickly, and inexpensively. Thus, an improved method for reducing impurities from sequencing reaction products is needed which is easy to use, fast, and inexpensive.

### SUMMARY OF INVENTION

The instant invention relates to a method and an apparatus useful for purifying DNA sequencing reaction products. Briefly, a gel filtration medium is combined with a molecular cutoff filter in a single apparatus to isolate DNA sequencing fragments from the sequencing template, enzyme, salt and nucleotides. A preferred embodiment of the instant apparatus depicted in FIG. 1 shows a cylindrical housing having openings at the top and bottom of the housing. The housing may take forms other than cylindrical, e.g., rectangular, octagonal, etc.

The apparatus may be used in conjunction with pressure and/or centrifugation to achieve the separation, and the addition of a detergent composition (nonionic, ionic, or zwitterionic), including a bile salt, may also be used.

### BRIEF DESCRIPTION OF THE DRAWINGS

The file of this patent contains at least one drawing executed in color. Copies of this patent with color drawing(s) will be provided by the Patent and Trademark Office upon request and payment of the necessary fee.

FIG. 1 depicts one embodiment of the apparatus according to the instant disclosure.

FIG. 2 is an electropherogram showing the separation of sequencing reaction products purified according to the instant method.

FIG. 3 is an electropherogram of purified sequencing reactions using ethanol precipitation that contains increasing amounts of plasmid DNA as the template.

### DETAILED DESCRIPTION OF THE INVENTION

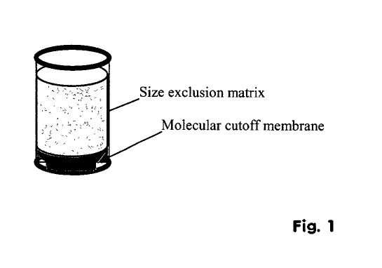

The invention pertains to a method and an apparatus useful for purifying DNA sequencing reaction products. According to the invention, a gel filtration medium is combined with a molecular cutoff filter into a single apparatus to isolate DNA sequencing fragments from the sequencing template, enzyme, salt and nucleotides. One possible embodiment of the instant apparatus depicted in FIG. 1 shows a cylindrical housing having openings at the top and bottom of the housing. The housing may take forms other than cylindrical, e.g., rectangular, octagonal, etc. The molecular cutoff filter (also referred to herein as a “membrane”) is attached to the bottom of the housing. In general, molecular cutoff filters must be well sealed to the container to avoid leakage from the sides and must also be strong to prevent perforation of the membrane during centrifugation. Preferred filters include those commercially available from Whatman Polyfiltronics. While the instant apparatus may be a single column format, most preferred are microtitre plates incorporating a molecular weight cutoff filter, such as Whatman Polyfiltronics Unifilter® MWCO 96 well filterplate, 800 μl per well, FSU 100 Kda polysulphone membrane gasketed with hydrophilic PVDF, commercially available from Whatman Polyfiltronics, Rockland, Mass.

A layer of gel filtration medium is added on top of the molecular weight cutoff filter and rehydrated using water containing 0.05% Kathon™ CG/ICP (Rohm and Haas Company). Preferably, the apparatus according to the instant disclosure includes Sephadex® or Sephacryl® gel filtration media, commercially available from Amersham Pharmacia Biotech Inc., Piscataway, N.J. Most preferably, the gel filtration medium is Sephadex G-50 Fine (CE Grade) a proprietary purification medium of Amersham Pharmacia Biotech AB, Uppsala, Sweden.

Samples to be purified are loaded onto the top of the gel filtration medium component of the apparatus, allowed to pass through the medium and through the molecular weight cutoff membrane, and collected for subsequent analysis. The samples may be assisted through the medium and membrane by centrifugation, by applying positive pressure, or by applying a negative pressure. Preferably, the apparatus is spun in a centrifuge at approximately 910× g for approximately 5 minutes prior to sample loading to remove the rehydration medium. The sample to be purified is then loaded onto the apparatus and spun in a centrifuge at approximately 910× g for approximately 6 minutes. Samples purified using the instant apparatus are ready for CAE. Additionally, the purified reactions may be mixed with or dried and resuspended in a loading buffer prior to CAE.

The apparatus may comprise a single unit, such as a chromatography column, e.g., a “spin” column. Preferably, the apparatus comprises a parallel processing unit, such as a microtitre plate containing multiple wells which allow for the purification of multiple samples at a time. Separation may also be enhanced by the application of negative or positive pressure, or centrifugal force. Additionally, the sequencing reaction product subjected to the purification may be admixed with a detergent (ionic, nonionic, or zwitterionic), including a bile salt, prior to the process to enhance recovery.

### EXAMPLES

The following examples are intended for illustrative purposes only and not intended to be illustrative of all embodiments.

### Definitions

The following definitions are used:

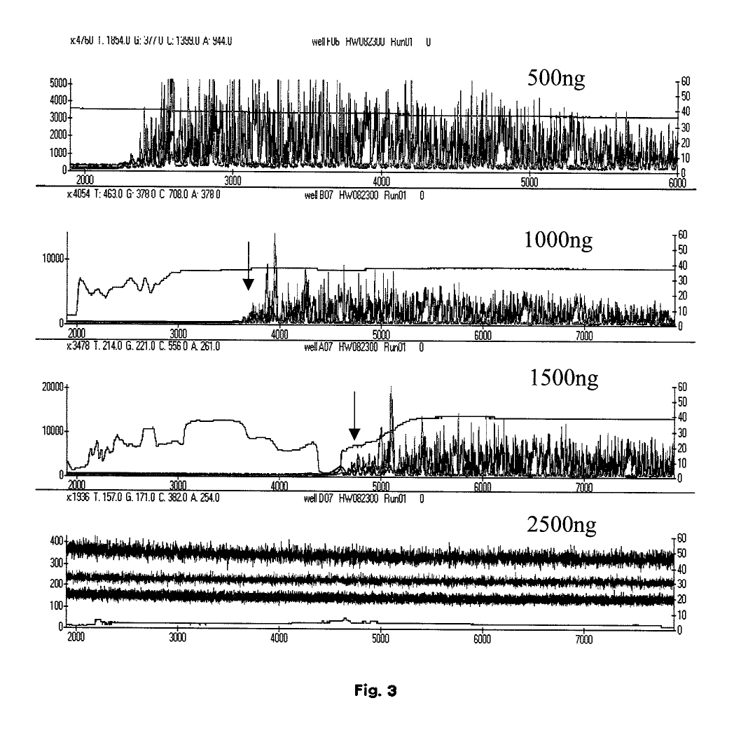

“Delayed start” is used to define a sequence where the first base does not appear in the expected electrophoretic time interval, but appears later in the electrophoresis run. Delays of sequence start may range from several minutes to the complete time used for the CAE (FIG. 3, arrows and bottom panel). These delays may be caused by current drops within the capillary, which may be caused by the use of excess template in the sequencing reactions.

“Water” is double distilled water having a resistance of ≧18 megohm/cm. Detergent is defined to include ionic, nonionic, and zwitterionic detergents and bile salts. Kda is defined as kilodalton(s).

“Conductivity” is measured in either millisiemens (mmho) or microsiemens (μmho), where one siemen is defined as one amp/volt or one mho.

### Example 1

To test if the cutoff size of 100 Kda was appropriate, cycle sequencing reactions were spiked with 200-800 ng of plasmid DNA (approximate size 3.4 kb; the sodium salt of 1 kb of duplex DNA is assumed to have a weight of 6.5×10² Kda (P-L Biochemicals Molecular Biology Catalog, Supplement 107)) and purified using Sephadex G-50 gel filtration medium in conjunction with a 100 Kda molecular weight cutoff filter in a 96 well plate.

Cycle Sequencing Reaction:

Templates were either M13mp18(+) strand (catalog #; lot #60815462 from Amersham Pharmacia Biotech Inc.) (M13) or pUC18 containing an 807 base insert of p53 cDNA cloned into the Sma I site (pUCp53). The pUCp53 cDNA contains parts of exons 4 and 10 and all of exons 5 through 9.

Primers used in the sequencing reactions were the modified M13 reverse primer (“MRP”), 5′-d(GGA ATT GTG AGC GGA TAA CA)-3′, (Cat#36008, from Amersham Pharmacia Biotech Inc.) or the modified M13 universal primer (“MUP”), 5′-d(GGT AAC GCC AGG GTT TTC C)-3′, (Cat#36009 from Amersham Pharmacia Biotech Inc.).

Sequencing kits were either DYEnamic™ ET Dye Terminator Kit (MegaBACE), (Amersham Pharmacia Biotech Inc. #US81090) or DYEnamic ET terminator Cycle Sequencing Kit (ABI) (Amersham Pharmacia Biotech Inc. #US81060).

A cycle sequencing reaction containing 1 μl to 11 μl template, 1 μl MUP or MRP (5 pmoles/μl), 8 μl pre-mix and 0 μl to 10 μl water (total volume of 20 μl) was subjected to thermal cycling conditions of 32 cycles, each cycle consisting of: 95° C. for 30 seconds, 50° C. for 15 seconds, and 60° C. for 60 seconds.

Purification & Separation by CAE

The instant apparatus was prepared by adding Sephadex G-50 Fine (DNA Grade), (Cat#17-0573-03, Amersham Pharmacia Biotech) to a 96 well microtitre plate (350 μl Clear Polystyrene Short Drip 0.45 um FSU100 Kda regenerated cellulose membrane gasketed with Hydrophilic PVDF commercially available from Whatman Polyfiltronics). The filtration medium was rehydrated in water containing 0.05% Kathon CG/ICP for 1 hour. The plates were centrifuged at 910× g for 5 minutes to remove the rehydration medium. Samples were then loaded and the plate centrifuged at 910× g for 6 minutes. The eluents after centrifugation were collected and added to a loading solution. The purified samples were subsequently loaded on to an ABI 377™ slab gel sequencing instrument for analysis. Sequence data showed read lengths over 600 bp. The result was a surprise because a 300 base sequencing fragment has an approximate weight of 100 Kda. It was expected that sequencing products greater in length than about 300 bases would not pass through the membrane.

### Example 2

Cycle sequencing reactions and subsequent purification were performed as described above, and the samples analyzed using a MegaBACE CAE instrument. In this experiment the plasmid, pUCp53, served as the template. The sequencing products were purified by EtOH precipitation and some were spiked with extra pUCp53 DNA. The samples spiked with extra pUCp53 DNA are denoted in the table, below, as 400+200, 600+200 and 800+400. The samples were split into two equal portions. One sample portion was analyzed directly by CAE. The other portion was purified using the instant apparatus before analysis by CAE. Results are presented in Table 1, below.

TABLE 1

| Amount | EtOH + Instant | | | | |
|---|---|---|---|---|---|
| of | Device | | EtOH only | | |
| Plasmid | Bases | Ambig- | Bases | | |
| (ng) | Called | uous | Called | Ambiguous | Comments |
| 400 | 580 | 0 | 280 | 7 | EtOH delayed |
| 600 | 580 | 1 | 0 | — | EtOH delayed |
| 800 | 560 | 1 | 200 | 1 | EtOH delayed |
| 400 + 200 | 680 | 2 | 230 | 1 | EtOH delayed |
| 600 + 200 | 700 | 2 | — | — | EtOH delayed |
| 800 − 400 | 720 | 2 | — | — | EtOH delayed |

All samples purified by ethanol precipitation showed delayed starts (EtOH delayed) and shortened or no read lengths. Those samples purified using the instant apparatus, either with or without extra plasmid spiked into the completed sequencing reaction prior to purification, had good read lengths and delayed starts were not observed.

### Example 3

Cycle sequencing reactions were performed as described above. Analysis of the purified sequencing fragments was carried out using a MegaBACE CAE unit. The plates contained Sephadex G-50 Fine (DNA Grade), (Cat#17-0573-03 (5 kg), from Amersham Pharmacia Biotech) added to either:

a) a Whatman Polyfiltronics Unifilter MWCO 96 well filterplate, 800 μl/well, FSU100 Kda polysulphone membrane gasketed with hydrophilic PVDF, Cat#SPR 111 from Polyfiltronics;

b) a Whatman Polyfiltronics MWCO 96 well filterplate, 800 μl/well, 300 Kda polysulphone membrane gasketed with hydrophilic PVDF; or

c) a Whatman Polyfiltronics 350 μl Clear Polystyrene Short Drip 0.45 μm PVDF hydrophilic membrane microplate device, Cat#SPR 154.

The gel filtration medium in the plates was rehydrated for 1 hour in water containing 0.05% Kathon CG/ICP. The plates were centrifuged at 910× g for 5 minutes before use to remove the rehydration medium. Samples were loaded onto the gel filtration medium and the plates centrifuged at 910× g for 6 minutes to collect purified products.

The plate with the 100 Kda membrane had a 100% success rate of generated sequence data over the entire range of input DNA template. In contrast, ethanol precipitation and the plate with the gel filtration medium alone showed delayed starts and shortened read lengths, particularly at the higher DNA template input amounts. The 300 Kda plate also demonstrated delayed starts and shortened read lengths at the higher DNA template input amounts (data not shown).

TABLE 2

| | Gel Filtration Media - 100 | | | | | | Gel Filtration | | |
|---|---|---|---|---|---|---|---|---|---|
| Amount | Kda Molecular Cutoff Filter | | | Ethanol Precipitation | | | Media Only | | |
| of plasmid | Called | | First peak | Called | | First peak | Called | | First peak |
| (ng) | bases | Amb* | Scan lines** | bases | Amb | Scan lines | bases | Amb | Scan lines |
| 400 | 760 | 0 | 5000 | 470 | 0 | 8 000 | 620 | 0 | 5000 |
| 600 | 790 | 0 | 5000 | — | — | 18 000 | 610 | 0 | 5000 |
| 800 | 480 | 0 | 5000 | 116 | 1 | 13 000 | 600 | 0 | 6000 |
| 400 + 200 | 710 | 1 | 5000 | 430 | 1 | 10 000 | 640 | 0 | 5000 |
| 600 + 200 | 720 | 0 | 5000 | 120 | 0 | 12 000 | 470 | 0 | 8000 |
| 800 + 400 | 560 | 0 | 5000 | — | — | — | 225 | 0 | 8000 |

*Amg is ambiguous
**A scan line for the MegaBACE used is defined as the cycling of the scan head down and back across the detection window in the capillaries once.

### Example 4

Sequencing reactions containing 10 μg bacteria artificial chromosome (BAC) DNA template, 20 pmol primer, 1× ABI ET terminator pre-mix, and an extra 20 units of Thermosequenase II™ DNA polymerase were subjected to 100 cycles, each cycle consisting of 95° C. for 20 seconds, 55° C. for 15 seconds, 60° C. for 1 minute. Additionally, the reactions were heated at 96° C. for two minutes prior to the start of thermal cycling. Control samples were purified using ethanol precipitation. Other samples were purified using 96-well microtitre plates equipped with 100 Kda membranes filled with Sephadex G-50 (DNA grade). Each column of G-50 was washed 4 times with 150 μl of water before addition of the samples. After addition of the wash, the plates were centrifuged as previously described to remove the water. Purified samples were collected as described previously. The samples were analyzed using a MegaBACE™ CAE unit.

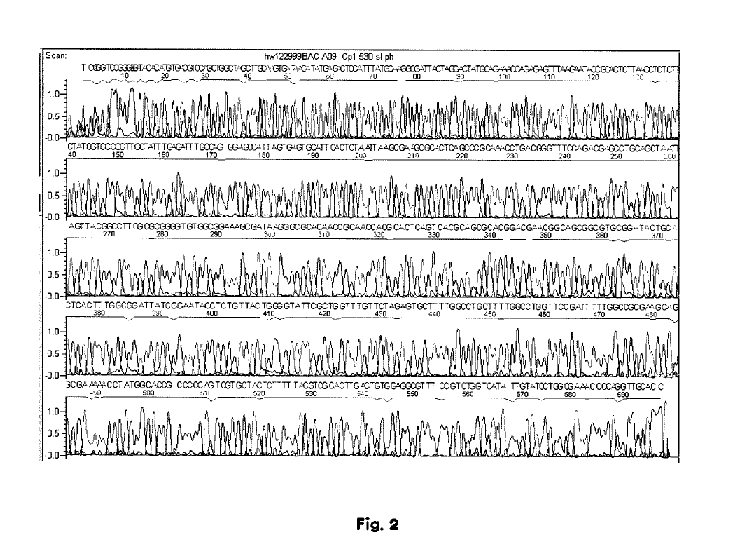

As shown in FIG. 2, base calls reached 500-600 with 98% accuracy and signal intensity was about 4000-5000 with very uniform peak heights. According to the sequencing data, the Sephadex G-50 100 Kda membrane plate could purify BAC DNA sequencing products and eliminate overloading problems on MegaBACE. In contrast, none of the control samples purified by ethanol precipitation showed any readable sequence.

### Example 5

We investigated why the G-50 needed to be washed 4-5 times prior to sample application in order to achieve optimum sequencing data results. Conductivities of the various sequencing reaction components were obtained and are summarized in Table 3.

TABLE 3

| Component | Conductivity (mmho) |
|---|---|
| Unpurified DYEnamic ET Dye | 4.28 |
| Terminator Kit (MegaBACE) | |
| Sequencing Reaction | |
| Unpurified DYEnamic ET | 9.06 |
| Terminator Cycle Sequencing Kit | |
| (ABI) Sequencing Reaction | |
| DYEnamic ET Dye Terminator Kit | 0.622 |
| (MegaBACE) Sequencing Reaction | |
| Purified With DNA Grade G-50 | |
| Alone (AutoSeq ™ 96 Dye | |
| Terminator Clean-Up Kit, | |
| Amersham Pharmacia Biotech Inc. | |
| #27-5340) | |
| DYEnamic ET Terminator Cycle | 0.650 |
| Sequencing Kit (ABI) Sequencing | |
| Reaction Purified With DNA Grade | |
| G-50 Alone (AutoSeq96) | |
| DYEnamic ET Dye Terminator Kit | 0.017 |
| (MegaBACE) Sequencing Reaction | |
| Purified With DNA Grade G-50 | |
| Washed 4X With Water Prior to | |
| Purification | |
| DYEnamic ET Terminator Cycle | 0.021 |
| Sequencing Kit (ABI) Sequencing | |
| Reaction Purified With DNA Grade | |
| G-50 Washed 4X With Distilled | |
| Water Prior To Purification | |

It is well known in the art that electrokinetic injection can be affected by the ionic strength of the material being injected, as well as the amount of sequencing fragment material present. Thus, the DNA Grade G-50 needed to be washed numerous times prior to sample addition in order to lower the conductivity of the purified, eluted material before electrokinetic injection. A comparison of conductivities of the rehydration medium from the two grades of Sephadex G-50 along with the washes may be found in Table 4.

TABLE 4

| Component | Conductivity (μmho) |
|---|---|
| Water | 0.9 |
| DNA Grade G-50, first wash eluent | 249 |
| DNA Grade G-50, second wash eluent | 90 |
| DNA Grade G-50, third wash eluent | 27 |
| DNA Grade G-50, fourth wash eluent | 5.1 |
| PVDF membrane wash | 2 |
| Polysulfone membrane wash | 17 |
| CE Grade* G-50 rehydration medium | 130 |
| CE Grade G-50 first wash eluent | 30 |

*Proprietary Capillary Electrophoresis (CE) Grade Sephadex G-50, Amersham Pharmacia Biotech AB, Uppsala, Sweden.

It became evident that the use of CE Grade G-50 would reduce the processing time with the instant apparatus.

### Example 6

Elemental analysis was performed on the DNA Grade G-50 to determine why the conductivity was so high. Results are presented in Table 5.

TABLE 5

| Component | Amount (mg/L) |
|---|---|
| Sodium | 165 |
| Sulfur | 65 |
| Magnesium | 3 |
| Calcium | 2 |
| Silicon | 2 |

Additionally, trace amounts (<1 mg/L) of aluminum, barium, beryllium, boron, chromium, copper, iron, nickel, potassium, seleniun, tungsten and zinc were also identified. The counter ions for these species would be problematic with electrokinetic injection of DNA samples.

### Example 7

In an effort to improve the amount of DNA sequencing products recovered from the instant apparatus, additions of ionic, nonionic detergents, a zwitterionic detergent, bile salts or a weakly acidic ion exchange medium to the completed sequencing reactions prior to purification were investigated. Sequencing reactions had between 20 μL to 100 μL of these solutions added to them prior to passage through the instant apparatus. The solutions comprised either, 0.025% Triton X-100 (US Biochemicals, Inc.), 0.025% Tween 20 (US Biochemicals, Inc.), 0.025% Nonidet P-40 (US Biochemicals, Inc.), 2 mM cholate (SIGMA), 2 mM deoxycholate (SIGMA), an equal admixture of 0.025% Tween 20 and 0.025% Nonidet P-40, or 1.667 mM CHAPS (J. T. Baker). Additionally, the sequencing reactions were also separately pretreated with Amberlite IRP-64 (SIGMA; 1 g wet weigh Amberlite IRP-64 equilibrated in sodium phosphate buffer, pH 8.0 added to 1 ml of water) prior to purification. Analysis of the data by read length showed the most preferred to least preferred embodiment in this aspect of the instant apparatus was:

Tween20 =Deoxycholate>Tween20+Triton X-100 mixture>CHAPS>Tween20+Nonidet P-40 mixture=Cholate>water>undiluted sequencing reaction>pretreatment with 2 μl of Amberlite IRP-64 solution>pretreatment with 5 μl of Amberlite IRP-64 solution

It was found that addition of detergent to the completed reactions could improve sequencing product recovery two to three fold.

It is apparent that many modifications and variations of the invention as hereinabove set forth may be made without departing from the spirit and scope thereof. The specific embodiments described are given by way of example only, and the invention is limited only by the terms of the appended claims.

What is claimed is:

1. An apparatus for removing constituents from sequencing reactions comprising a housing having a first opening and a second opening, wherein said housing contains a first zone comprising a separation medium, and a second zone comprising a membrane.

2. The apparatus of claim 1, wherein the separation medium is a gel filtration medium.

3. The apparatus of claim 1, wherein the membrane is a molecular weight cut-off membrane.

4. The apparatus of claim 1, wherein the housing is a single unit.

5. The apparatus of claim 1, wherein the housing is a a parallel processing unit.

6. A method for purifying a sequencing reaction product that comprises contacting said sequence reaction product with the first zone and the second zone of the apparatus of claim 1, and isolating the sequencing reaction products.

7. The method of claim 6, further comprising the step of subjecting the apparatus to centrifugal force.

8. The method of claim 6, further comprising the step of subjecting the apparatus to positive or negative pressure.

9. The method of claim 6, further comprising admixing said sequencing reaction product with a detergent to improve sequencing fragment recovery through the apparatus.

10. The method of claim 9, wherein the detergent is nonionic.

11. The method of claim 9, wherein the detergent is ionic.

12. The method of claim 9, wherein the detergent is a bile salt.

13. The method of claim 9, wherein the detergent is a zwitterion.

14. The method of claim 2, wherein the separation medium is a gel filtration medium of low conductivity.
